(19) United States
(12) Patent Application Publication
(10) Pub. No.: US 2014/0039914 A1
(43) Pub. Date: Feb. 6, 2014

(54) SYSTEM AND METHOD FOR PROMOTING WELLNESS

(71) Applicants: Dana Dansereau, Scottsdale, AZ (US); N. Scott Burkhardt, Scottsdale, AZ (US); Sabrinea Mae Suazo, Denver, CO (US)

(72) Inventors: Dana Dansereau, Scottsdale, AZ (US); N. Scott Burkhardt, Scottsdale, AZ (US); Sabrinea Mae Suazo, Denver, CO (US)

(21) Appl. No.: 13/957,267

(22) Filed: Aug. 1, 2013

Related U.S. Application Data
(60) Provisional application No. 61/678,680, filed on Aug. 2, 2012.

(51) Int. Cl. G06F 19/00

(52) U.S. Cl. CPC G06F 19/345
USPC 705/2

(57) ABSTRACT

A system can administer a new medical therapy combining whole body vibration and targeted laser treatment. The system can include one or more modules to analyze a client and, based on the analysis of the client, generate a care program. The analysis can determine the client's suitability for the combined laser treatment and vibration therapy. If the client is suitable, the system provides vibration therapy with the laser treatment. Then, the system can generate a follow-up program, including reassessing the client's suitability for combined laser treatment and vibration therapy. The follow-up program can adjust the care program based on the reassessment of the client to maximize the effectiveness of the care program.

### CROSS REFERENCE TO RELATED APPLICATIONS

The present application claims the benefit of and priority to, under 35 U.S.C. §119(e), U.S. Provisional Application Ser. Nos. 61/678,680, filed on Aug. 2, 2012, entitled “System and Method for Promoting Wellness.” which is incorporated herein by reference for all that the application teaches and for all purposes.

### BACKGROUND

Systems and methods exist that promote wellness in individuals. These systems and methods tend to have a singular focus and a singular means of producing change. Current systems tend not to integrate features or efforts of other systems or other methods. Further, current methods tend not to focus on individuals but provide a plan that is not specific. The methods heretofore known suffer from a number of disadvantages including but not limited to being ineffective, not improving client quality of life, failing to manage pain, failing to produce weight-loss, failing to produce weight-loss at an appropriate rate, failing to reduce pain, failing to increase mobility, and failing to address or causing medical maladies, having a high failure rate among clients, being uncomfortable, and not being customizable.

### SUMMARY

The embodiments presented herein relate to systems and methods for administering a new medical therapy combining whole body vibration and targeted laser treatment. The system and methods can include one or more modules to analyze a client and, based on the analysis of the client, generate a care program. The analysis can determine the client's suitability for the combined laser treatment and vibration therapy. If the client is suitable, the system provides vibration therapy with the laser treatment. Then, the system can generate a follow-up program, including reassessing the client's suitability for combined laser treatment and vibration therapy. The follow-up program includes a feedback program that can give the client information on the efficacy of the vibration and laser treatment. Further, the follow-up program can adjust the care program based on the reassessment of the client to maximize the effectiveness of the care program.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity,” as used herein, refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium,” as used herein, refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The term “display,” as used herein, refers to a portion of a screen used to display the output of a computer to a user.

The terms “determine”, “calculate” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

As used herein, “comprising,” “including,” “containing,” “is,” “are,” “characterized by,” and grammatical equivalents thereof are inclusive or open-ended terms that do not exclude additional unrecited elements or method steps.

Many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the embodiments may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the embodiments may be implemented with TCP/IP communications protocols, the embodiments may also be implemented using IPX, AppleTalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference in their entirety and for all purposes.

The terms “weight-loss” and “inch-loss” are used interchangeably herein. The terms customized and personalized are used interchangeably herein.

The term “module,” as used herein, refers to any known or later developed hardware, software, firmware, artificial intelligence, fuzzy logic, or combination of hardware and software that is capable of performing the functionality associated with that element.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

The embodiments will be described and explained with additional specificity and detail through the use of the accompanying drawing(s), in which:

FIG. 1 is a block diagram of an embodiment of a system of promoting wellness;

FIG. 2 is a block diagram of an embodiment of an assessment module;

FIG. 3 is a block diagram of an embodiment of a treatment module;

FIG. 4 is a block diagram of an embodiment of a follow-up module; and

FIG. 5 is a block diagram of an embodiment of a data storage for storing wellness information;

FIG. 6 is a block diagram of an embodiment of a method of promoting wellness;

FIG. 7 is a block diagram of an embodiment of a method of assessing a client;

FIG. 8 is a block diagram of an embodiment of a method of treating a client;

FIG. 9 is a block diagram of an embodiment of a method of reassessing a client;

FIG. 10 is a block diagram of an embodiment of a computer environment; and

FIG. 11 is a block diagram of an embodiment of a computing system.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

For the purposes of promoting an understanding of the disclosure, reference will now be made to the exemplary embodiments illustrated in the drawing(s), and specific language will be used to describe the same. It will nevertheless be understood that no limitation of the scope of the embodiments is thereby intended. Any alterations and further modifications of the inventive features illustrated herein, and any additional applications of the principles of the embodiments as illustrated herein, which would occur to one skilled in the relevant art and having possession of this disclosure, are to be considered within the scope of the embodiments. The systems herein can comprise single devices or a compilation of devices. This device, or these devices, may be capable of communicating with other devices and/or to an individual or group of individuals. Further, this device, or these devices, can receive user input in unique ways. The overall design and functionality of each device provides for an enhanced user experience making the device more useful and more efficient. As described herein, the device(s) may be electrical, mechanical, electro-mechanical, software-based, and/or combinations thereof.

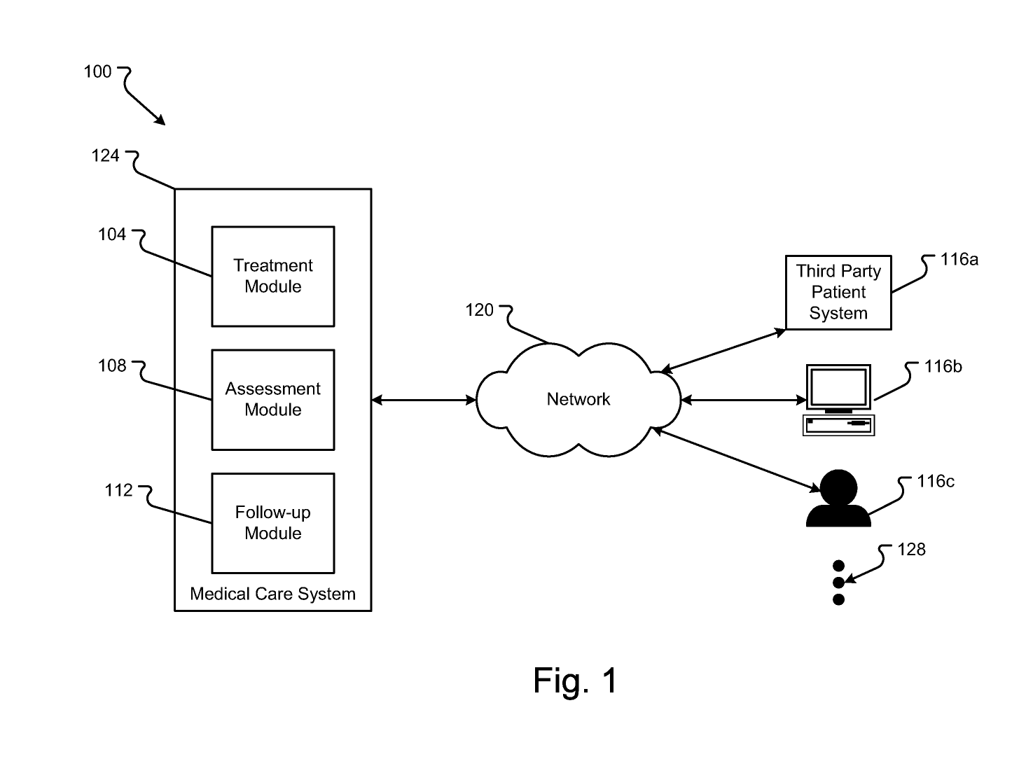

A system 100 of promoting wellness is shown in FIG. 1. The system 100 can include a medical care system 124 that includes a treatment module 104, an assessment module 108, a follow-up module 112, and one or more of a client 116c, client computer 116b, or third party system 116a (or other systems or devices related to clients as represented by ellipses 128), all in communication with one another over a network 120. Accordingly, the client or client care facility 116 may have access to the various modules as appropriate to carry out the methods/processes described herein and/or to provide one or more of the benefits described herein.

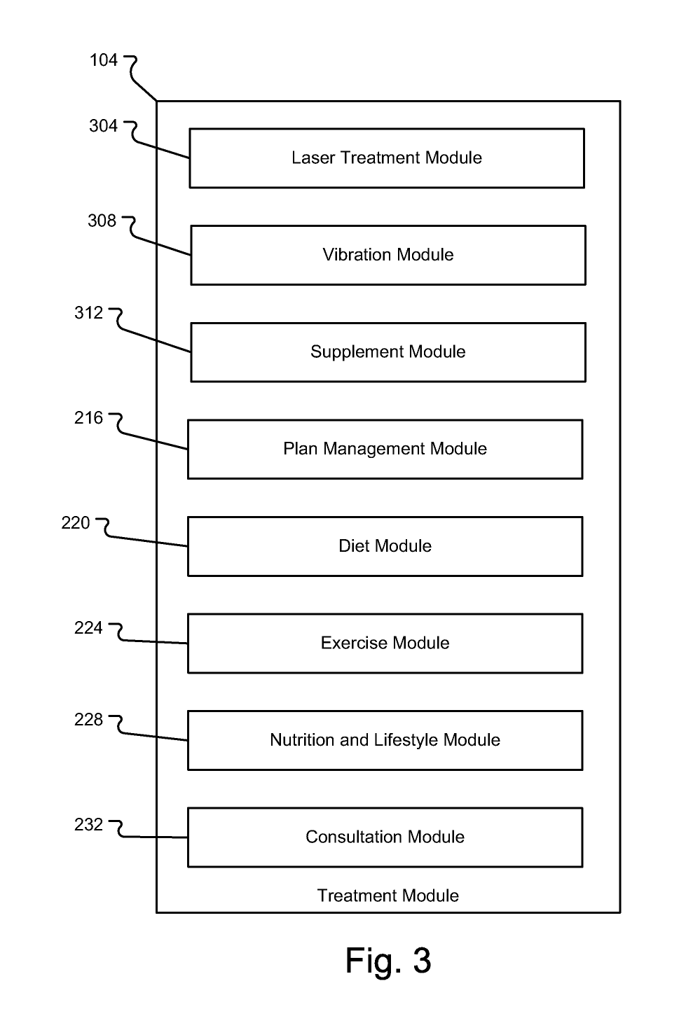

The treatment module 104 provides medical treatment of one form or another and includes one or more modules/devices/structures/processes/etc. that provides medical treatment for one or more clients. An embodiment of the treatment module 104 is described in conjunction with FIG. 3.

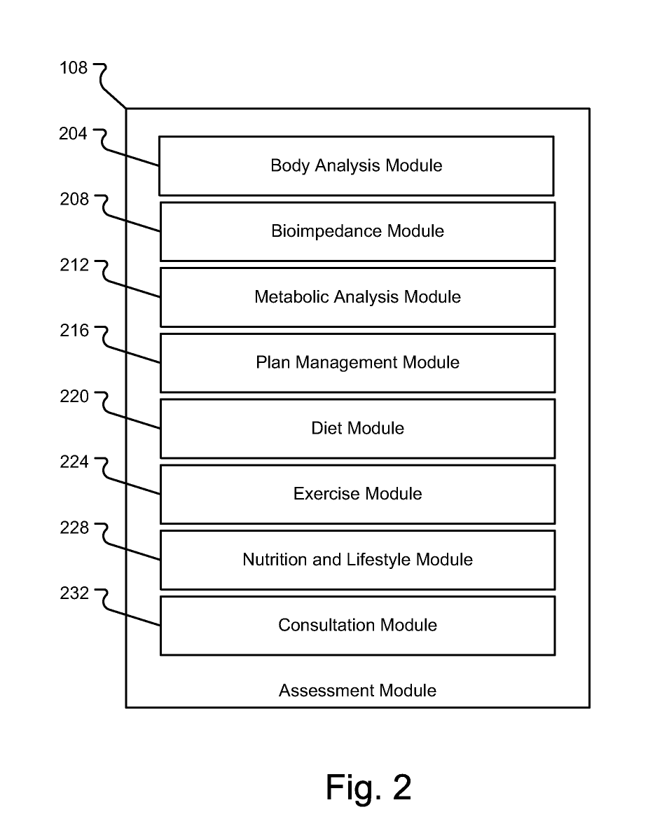

The assessment module 108 provides assistance in assessing and/or reassessing a client and one or more modules/devices/structures/processes/etc. that provide assistance in determining the condition for one or more clients. An embodiment of the assessment module 108 is described in conjunction with FIG. 2.

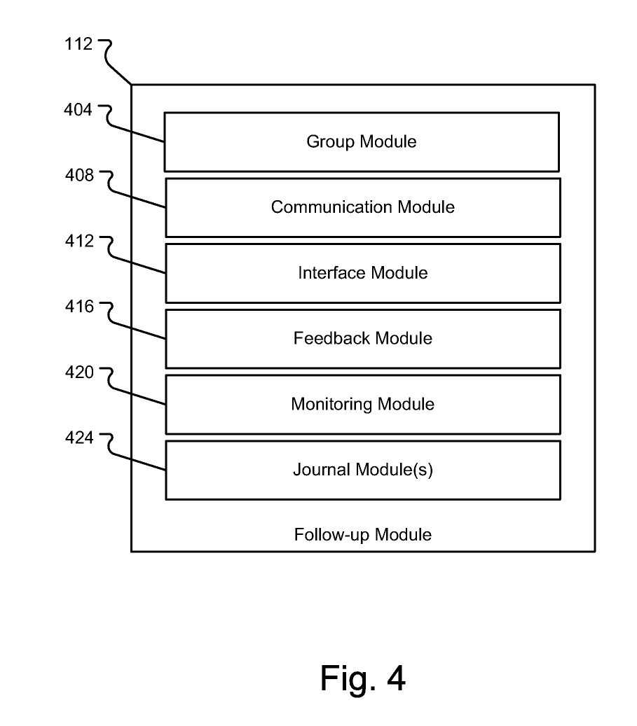

The follow-up module 112 provides follow-up to clients to help them keep on track and/or provide a medium for feedback and includes one or more modules/devices/structures/processes/etc. that provide follow-up for one or more clients. An embodiment of the follow-up module 112 is described in conjunction with FIG. 4.

The client/client care facility 116 may be/include facilities, structures, devices, systems, kits, processes, and/or locations such as one or more of, but not limited to, a clinic, hospital, home care kit, ambulance, portable care equipment, and the like and combinations thereof. Regardless of system or device, the client care facility 116 can interface with a client 116c.

Advantageously, the system 124 provides synergistic benefits of the various described modules in a manner that permits the synergistic benefits to occur and helps to enhance the same. Notably, system 100 can promote wellness including a system 124 to help people with weight, mobility and/or pain management issues using a plurality of supports/techniques, including but not limited to two or more of: laser therapy, whole body vibration technology, nutritional support, medical grade supplements, and emotional and other support. Such methods, when combined, provide synergistic results that are better than the expected additive benefits of the techniques when used alone.

It is believed that the laser penetrates the fat cell, and opens a pore so the toxins are allowed to drain. The toxins consist of glycerides, water, and free fatty acids. The laser paddles are generally placed on the skin in the area where fat reduction or blood stimulation is desired. There can be four paddles and two smaller laser ‘probes’ or diodes placed on one or more lymph nodes or on the patient's skin; these are used to stimulate the lymph nodes and help eliminate the fat that has been released from the toxic cells. So, the laser opens fat cells to allow them to drain, and the vibration module further stimulates the lymphatic system so that toxins are more quickly eliminated. In other embodiments, the laser system includes 4 armatures that include 8 diodes that may be placed on the patient's skin.

In general 1/3 of the fat is re-absorbed into the body and stored as fat if you do not add the whole body vibration (wbv). When this technique is included, more fat is eliminated, and less fat is re-absorbed and stored as fat. Since the fat cells remain open for 72 hours, it is helpful to assure that toxins are eliminated as much as possible. It is also believed that the laser also stimulates the blood flow, and when the blood is flowing the added benefits of increased energy and additional healing properties are recognized.

The system 100 may include an individualized/personalized plan, for each client, based on their body composition and/or their specific needs. The client needs may be determined by one or more tests, interviews, consultations, and the like. Such may include performing a bio-impedance analysis (and/or another test or group of tests that generally measures and/or provides information about one or more of body cell mass, extracellular mass, lean body mass, fat mass, body mass index, basal metabolic rate, hydration, intra and extracellular water, fat to muscle ratios, etc.) together with an in-depth nutritional and lifestyle consultation (e.g., question wizard applications, questionnaires, online forms, direct personal observation for a time period, interviews, interviews with associates/friends/family, visual inspection, and/or medical examinations and the like, and combinations thereof) to determine/establish one or more parameters of a customized/personalized treatment program for the client.

Further, the system 100 may be implemented in a one-on-one or small group setting, especially small groups of like individuals (e.g., people having similar problems, issues, goals, demographics, similar skill/ability to perform/participate in treatment, etc.) wherein accountability is present, but the prospects of embarrassment, confusion, or other unpleasantness may be minimized and/or avoided.

Then, a follow-up module 112 may be implemented to assure better results. The follow-up module 112 may include computer-aided follow-up, self-monitoring using technology or otherwise, group follow-up, providing clients with journals, and the like and combinations thereof.

Follow-up may show that results are not being achieved and that metabolic testing may be needed to determine if there are any metabolic disorders that may be getting in the way of results. Such metabolic testing may include one or more blood panels/blood work and/or interviews, questionnaires, and/or medical examinations.

In another non-limiting example, there is a laser device with multiple (four or more) paddles instead of just the four generally present on such machines. Also there may be a body scan type of device(s) to measure inches, fat, etc and/or to potentially photograph the body for before and after pictures. Such information may be input into a special software program to give more information/feedback/analysis about body composition, body fat, etc. One could also track via computer client progress with more accurate results. This information may then be provided to researchers for upgrades to the existing devices, or development of new devices and/or treatment parameters. Additionally, there may be a laser module that may specifically not include a belt to hold the paddles in place, but instead may use another structure/process/device/composition to do the same.

The following are additional non-limiting examples of variations on a system/method of promoting wellness:

The system 100 may include use of a device that by attaching electrodes to the extremities of the body and sending various current/frequencies, one may determine body composition, organ function, and/or supplement requirements.

The system 100 may include attaching one or more heart rate monitors to the clients and monitor them while they are exercising at a clinic. It may also include wirelessly sending the results to a clinic computer and tracking results over time.

The system 100 may include providing a smartphone/tablet application that allows a person to verbally describe what they are eating and/or records this description. The clients do this before they start the meal. The application then interprets the stated information using a voice recognition module and then converts the interpreted information to expected calories, vitamins, etc. The application may track the results over time to see if the client is sticking to their diet.

The system 100 may include providing access (e.g., read/write/change/communicate/etc) to clients and/or operators/clinicians over a “cloud” network so that they may be enabled to log in and see their progress, order vitamins, schedule more exercise, etc.

There may be a compression garment, like that produced under the brand Spanx, that has built into it laser diodes. Small, flat batteries may also be sewn into this garment. This design allows the user to wear the garment all day and receive treatment continuously, either to melt fat, or to manage pain (perhaps a sprained ankle, knee, elbow, etc.). The garment would be elastic, and the user slips it on over the affected area. The device may also be great for treating someone who has edema, as the compression is good, synergistically enhancing the diodes. The device might also be a good solution for burn victims. Burns heal from the perimeter, so the healing rate could be enhanced at the perimeter.

An assessment module 108 is shown in FIG. 2. The assessment module 108 can include a body analysis module 204, a bio-impedance module 208, a metabolic analysis module 212, a plan management module 216, a diet module 220, an exercise module 224, a nutrition and lifestyle module 228, and a consultation module 232. Each module 204-232 can be in sufficient communication with the other modules to perform its respective function, and, in one or more non-limiting embodiments, to perform one or more of the processes, tasks, steps, methods described herein, and/or to provide one or more of the benefits, features, and/or advantages described and/or implied herein.

The body analysis module 204 can provide analysis of body characteristics such as one or more of, but not limited to, height, weight, blood pressure, blood panel results, bio-impedance test results, interview question answers/responses, and the like and/or combinations thereof. The body analysis module 204 may include storage, analysis, computational derivation of other characteristics/statistics based on provided information, and/or suggested treatment protocols based on input information.

The bio-impedance module 208 can provide bio-impedance testing and can include one or more devices for measuring bio-impedance of in individual. A non-limiting example of a bio-impedance module 208 includes the BIOMarkers 2000 Body Scan Analyzer by FirstLine Therapy of San Clemente, Calif. Another bio-impedance module 208 includes the ES Complex S/W from LD Technologies of Miami, Fla.

The Biomarkers 2000 Body Scan Analyzer is a portable, battery-powered bioimpedance (BIA) analyzer. Client assessments are conducted using a connection between the analyzer and the wrist and ankle of the client. Connections to the client are through standard ECG sensor pad electrodes. Resistance and reactance, the two components of impedance, are measured directly from the body. Using regression analysis the BIA analyzer computes:

Resistance (R)

Reactance (X)

Phase Angle (α)

Body Capacitance (C)

Fat-Free Mass (FFM)

Body Cell Mass (BCM)

Extracellular Mass (ECM)

Fat Mass (FM)

ECM/BCM

Body Mass Index (BMI)

Basal Metabolic Rate (BMR)

Total Body Water (TBW)

Intracellular Water (ICW)

Extracellular Water (ECW)

TBW/Fat-Free Mass

TBW/Total Weight

Results are printed using the analyzer's built-in thermal printer. The analyzer is powered by a built-in rechargeable battery pack. Carrying case, battery charger, client cable, sensor pad electrodes, print rolls, and user's guide are included.

The metabolic analysis module 212 provides information and/or analysis about metabolic and/or other health characteristics of a client and may include one or more systems, processes, and/or devices configured to do blood or other fluid testing on an individual. The metabolic analysis module 212 may automatically collect, store, record, analyze, develop, or otherwise process metabolic information from a client. The following is a non-limiting example of a blood panel and may be obtained by the metabolic analysis module 212:

The Basic Metabolic Panel (BMP) is a frequently ordered panel of tests that gives your doctor important information about the current status of your kidneys, blood sugar, and/or electrolyte and acid/base balance. Abnormal results, and especially combinations of abnormal results, can indicate a problem that needs to be addressed. The BMP is a group of 8 specific tests that have been approved, named, and assigned a CPT code (a Current Procedural Terminology number) as a panel by Medicare. Since the majority of insurance companies also use these names and CPT codes in their claim processing, this grouping of tests has become standardized throughout the United States. The BMP includes:

Glucose

Calcium

Both increased and decreased levels can be significant.

Electrolytes:
Sodium
Potassium
CO2 (carbon dioxide, bicarbonate)
Chloride

The concentrations of sodium and potassium are tightly regulated by the body as is the balance between the four molecules (i.e., sodium, potassium, CO2, and chloride). Electrolyte (and acid-base) imbalances can be present with a wide variety of acute and chronic illnesses. Chloride and CO2 tests are rarely ordered by themselves. Other tests conducted by the metabolic analysis module 212 may include:

Kidney Tests

BUN (blood urea nitrogen)

Creatinine

BUN and creatinine are waste products filtered out of the blood by the kidneys. Increased concentrations of these chemicals or molecules in the blood may indicate a temporary or chronic decrease in kidney function. When not ordered as part of the BMP, they are still usually ordered together.

The BMP uses a tube of blood collected by inserting a needle into a vein your arm. Depending on the reason for ordering the BMP, it may be drawn after fasting or on a random basis.

The BMP is used to monitor hospitalized clients and to monitor clients with some known conditions, such as hypertension and hypokalemia. If your doctor is interested in following two or more individual BMP components, she may order the entire BMP because it offers more information. Alternatively, she may order individual tests when monitoring, such as a follow-up glucose, potassium, or calcium, or order an electrolyte panel to monitor sodium, potassium, chloride, and CO2. If your doctor wants more information, she may order a Complete Metabolic Panel (CMP), a group of 14 tests that includes the BMP.

The BMP is often ordered in the hospital emergency room setting because its components give doctors important information about the current status of your kidneys, electrolyte and acid/base balance, blood sugar, and calcium levels. Significant changes in these test results can indicate acute problems, such as kidney failure, insulin shock or diabetic coma, respiratory distress, or heart rhythm changes. The test may be ordered when you see your doctor for a routine health exam.

The plan management module 216 can provide for storage, development, revision, coordination and/or management of one or more treatment and/or care plans and may include software and/or hardware for the same. The plan management module 216 may be provided by CRM tools, product management tools, and the like.

The diet module 220 can provide for the assessment of a person's diet through tracking of eating habits or other tests. The diet module 220 can include storage, development, revision, coordination, facilitation and/or management of a diet or eating plan and may include software and/or hardware for the same.

The exercise module 224 may provide for the assessment of a person's fitness through tracking of weekly exercise, fitness tests, or other tests. Further the exercises module 224 can include storage, development, revision, coordination, facilitation and/or management of an exercise plan and may include software and/or hardware for the same.

The nutrition and lifestyle module 228 may provide for the assessment of a person's lifestyle through tracking of a client's habits or other tests. Further the nutrition and lifestyle module 228 can provide for storage, intake, development, revision, coordination, facilitation and/or management of a nutrition and/or lifestyle plans and may include software and/or hardware for the same.

The consultation module 232 may provide storage, development, revision, coordination, facilitation and/or management of a client consulting and may include software and/or hardware for the same. Client care software and/or CRM tools may be so utilized.

A treatment module 104 is shown in FIG. 3. The treatment module 104 can include a laser treatment module 304, a vibration module 308, a supplement module 312, a plan management module 216, a diet module 220, an exercise module 224, a nutrition and lifestyle module 228, and a consultation module 232. Each module 304-312 may be in sufficient communication with the other modules to perform its respective function, and, in one or more non-limiting embodiments, to perform one or more of the processes, tasks, steps, methods described herein and/or to provide one or more of the benefits, features, and/or advantages described and/or implied herein.

The laser treatment module 304 can provides laser therapy/treatment and/or management/control thereof and may include one or more laser therapy devices along with control, diagnostic, utilization tracking, and/or coordination tools/modules configured to facilitate in the operation thereof and the integration of the laser treatment device with other modules described herein. A non-limiting example of a laser treatment module includes the Zerona by Erchonia of McKinney, Tex. and the Yolo Curve by Yolo Medical, Inc. of Surrey, BC Canada.

The ERCHONIA® Laser Scanner is specially designed for use during Liposuction and non-invasive body contouring (ZERONA®). The medical laser is applied externally and has proven through double-blind clinical trials to emulsify adipose tissue.

ZERONA® is a new body-sculpting procedure designed to remove fat and contour the body without invasive surgery. ZERONA® unlike other procedures, allows the client to continue their daily activities without interruptions from surgery, pain, wounds or garments. ZERONA® works by utilizing the Erchonia® Laser Scanner (FDA market cleared for laser assisted liposuction) to emulsify adipose tissue which then releases into the interstitial space. The excess fat is passed through the body during its normal course of detoxification. The ZERONA® procedure was proven through a double-blind, randomized, multi-site, and placebo controlled study in which clients averaged a loss of 3-4 inches compared to the placebo group that lost only a half an inch.

The YOLO Curve was designed to emit energy in the visible and infrared spectrum. The YOLO Curve uses laser energy to safely (and painlessly) penetrate the skin and provide temporary increase in blood circulation, relief of arthritic pain, relief of minor muscle and joint pain and stiffness.

Rather than a painful incision, the YOLO Curve is able to penetrate the skin to provide topical heating for the purpose of elevating tissue temperature. This results in the increase of localized blood circulation allowing for the temporary relaxation of muscle tissue and muscle spasms.

The vibration module 308 may provide body vibration therapy and includes one or more devices configured to cause vibrations to be transmitted through a body of a client. A non-limiting example of a vibration module includes the Power Plate Pro 5, Pro 6, or Pro 7 by Power Plate North America, Inc. of Irvine, Calif.

The supplement module 312 can provide for storage, development, revision, coordination, facilitation and/or management of a supplement plan and may include software and/or hardware for the same.

If not provided by the assessment module 108, the plan management module 216 can provide for storage, development, revision, coordination and/or management of one or more treatment and/or care plans and may include software and/or hardware for the same. The plan management module 216 may be provided by CRM tools, product management tools, and the like.

If not provided by the assessment module 108, the diet module 220 can include storage, development, revision, coordination, facilitation and/or management of a diet or eating plan and may include software and/or hardware for the same.

If not provided by the assessment module 108, the exercise module 224 can include storage, development, revision, coordination, facilitation and/or management of an exercise plan and may include software and/or hardware for the same.

If not provided by the assessment module 108, the nutrition and lifestyle module 228 can provide for storage, intake, development, revision, coordination, facilitation and/or management of a nutrition and/or lifestyle plans and may include software and/or hardware for the same.

If not provided by the assessment module 108, the consultation module 232 may provide storage, development, revision, coordination, facilitation and/or management of a client consulting and may include software and/or hardware for the same. Client care software and/or CRM tools may be so utilized.

A follow-up module 112 is shown in FIG. 4. The follow-up module 112 may include a group module 404, a communication module 408, an interface module 412, a feedback module 416, a monitoring module 420, and a journal module 424. Each module 404-424 can be in sufficient communication with the other modules to perform its respective function, and, in one or more non-limiting embodiments, to perform one or more of the processes, tasks, steps, methods described herein and/or to provide one or more of the benefits, features, and/or advantages described and/or implied herein.

The group module 404 may provide for storage, development, revision, coordination, facilitation and/or management of a group of similar clients and may include software and/or hardware for the same. The group module 404 may be implemented through CRM and/or project management tools.

The communication module 408 can provide communication between modules described herein and/or with an outside network and may include one or more network adaptors such as but not limited to network cards that operate on a TCP/IP protocol, wireless adaptors, cellular network adaptors, and the like and combinations thereof.

The interface module 412 may provide one or more interfaces for users to operate and thereby interact with one or more modules described herein and may include one or more video displays (LCD, CRT, etc.), smartphones, computers, tablets, keyboards, mice, kiosks, and the like and combinations thereof.

The feedback module 416 can provide for collection, storage, development, revision, coordination, facilitation and/or management of feedback, particularly from clients, but also from others who may be involved and may include software and/or hardware for the same. As a non-limiting example, there may be an email campaign managed by a campaign managing tool such as that provided under the brand Mail Chimp that may send out one or more online forms and/or questionnaires to a list of subscribers that may include clients. The sending of such mailings may be coordinated with one or more other activities or tasks described herein, such as but not limited to being sent on the same day, prior to, after, conditional on, and the like and combinations thereof.

The monitoring module 420 can provide for storage, development, revision, coordination, facilitation and/or management of monitoring client characteristics having to do with health plan compliance, and the like and may include software and/or hardware for the same. The monitoring module 420 can be implemented using project management tools.

The journal module 424 may provide for storage, development, revision, coordination, facilitation and/or management of a personal record of treatment and plan compliance for a particular client and may include software and/or hardware for the same. The journal module 424 may be implemented using document creation tools and/or fillable form wizards.

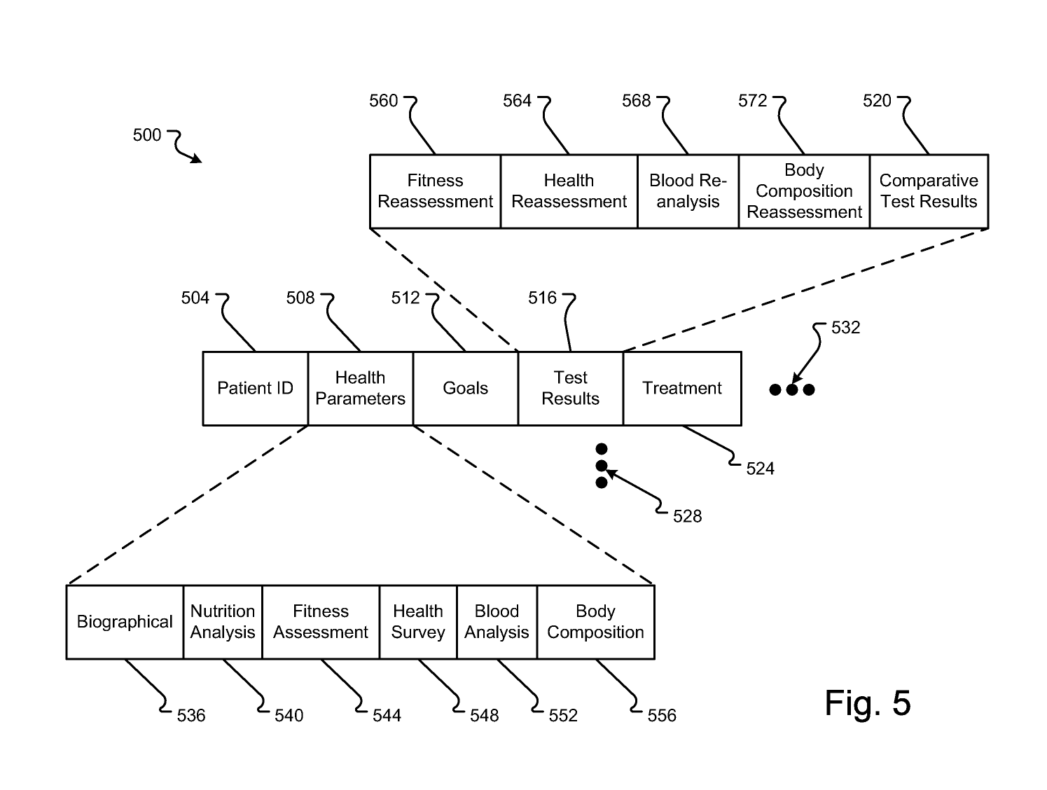

An embodiment of a data structure in a client database 500 is shown in FIG. 5. In embodiments, the logical data structure 500 includes one or more portions, fields, attributes, etc. that store data in a logical arrangement that allows for easy storage and retrieval of the information. Hereinafter, these one or more portions, fields, attributes, etc. shall be described simply as fields. The data structure 500 can include fields for storing data associated with a client identifier (ID) 504, client health parameters 508, client goals 512, client test results 516, client comparative test results 520, and/or client treatment plans 524. There may be more or fewer fields in the data structure 500, as represented by ellipses 532. Further, while only a single logical data structure 500 is shown in FIG. 5, there may be a data structure 500 for each client in a database as represented by ellipses 528.

The client identifier (ID) 504 can include information that identifies or is associated with the client. For example, the client ID 504 can include a unique number or code that distinguishes the client. The client ID 504 can be any globally unique identifier (GUID), biometric information, a numeric code, an alpha numeric code, a symbolic code, or other identifier. In embodiments, the client ID 504 can also include biographical data, for example, the client's address, phone number, email address, etc.

The client health parameters 508 can include a client health data that may have been generated from tests, measurements, surveys, consultations, etc. For example, the client health parameters 508 may include biographical information 536, nutrition analysis information 540, a fitness assessment 544, a health survey 548, blood analysis 552, and/or a body composition assessment 556. The biographical information can include the client's height, weight, age, sex, or other data. The health survey 548, blood analysis 552, and/or a body composition assessment 556 can include the client's body mass index, body fat percentage, past ailments, current medications, current ailments, past surgeries, etc. A client's nutrition analysis information 540 and/or a fitness assessment 544 can include information about a client's exercise routine or level and diet or other lifestyle information. The client health parameters 508 describe the client's current and past health.

Client goals 512 can include any objectives that the client desires to meet. The client goals 512 can include weight loss objectives, fitness objectives, pain management objectives, health objectives, etc. The client goals 512 describe what type of health the client would like to have in the near or distant future.

The client test results 516 can include any information from any test conducted on the client. In particular, the client test results 516 can include any assessments or reassessments of the client. The client test results 516 may include a fitness reassessment 560, a health reassessment 564, blood reanalysis 568, body composition reassessment 572, and/or comparative test results 520. Any of the fitness reassessment 560, health reassessment 564, blood reanalysis 568, and/or body composition reassessment 572 may be tests, surveys, consultations, or other processes (especially as explained in conjunction with FIG. 2) re-accomplished after treatment has been performed. Thus, any test (e.g., EKG, BMP, CMP, fitness test, body measurement, etc.) can have results entered into this field. This test data can allow for the assessment of a client's current health, determine if objectives are being met, and provide a source of empirical feedback for the client.

The client comparative test results 520 can include any test results that help a client determine their health status with relation to a population or other person. For example, body fat percentage can be compared to other people of like age and sex. These comparisons allow a client to determine their health level in comparison to other people. This data can provide a source of motivation for the client.

The client treatment plans 524 can include any information about a plan or strategy for how the client will attempt to meet their health objectives. The plans 524 can include information about weight loss, pain management, becoming fit, etc. This data 524 provides the link between where the client is with relation to the health and how they will achieve their goals.

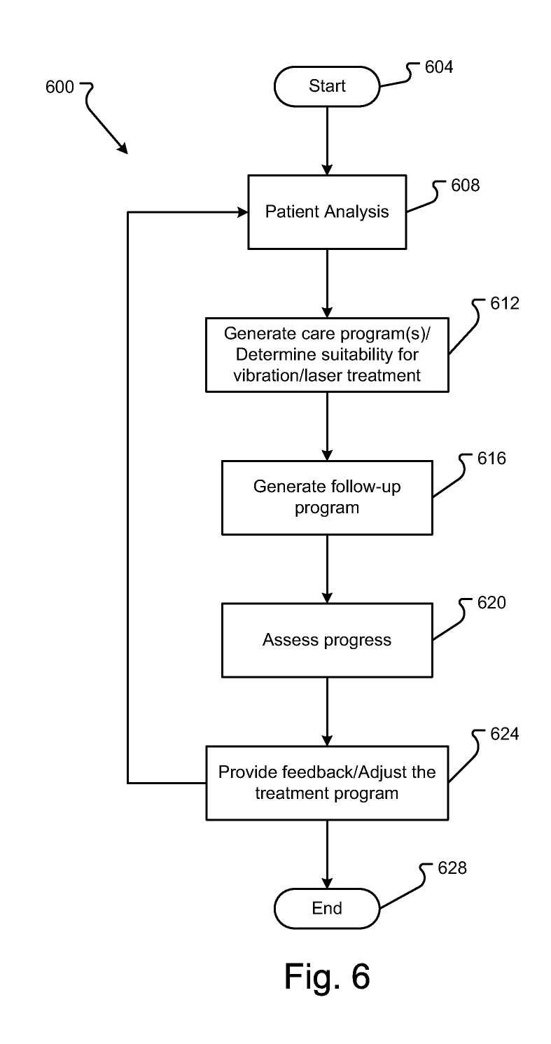

An embodiment of a method for promoting wellness is shown in FIG. 6. Generally, the method 600 starts with a start operation 604 and ends with an end operation 632. The method 600 can include more or fewer steps or can arrange the order of the steps differently than those shown in FIG. 6. The method 600 can be executed as a set of computer-executable instructions executed by a computer system and encoded or stored on a computer readable medium. Hereinafter, the method 600 shall be explained with reference to the systems, components, modules, software, data structures, user interfaces, etc. described in conjunction with FIGS. 1-5. Advantageously, such a process permits for very high levels of success for clients desiring weight loss and/or pain management, along with other enhanced health characteristics. The inventors have seen much higher levels of success in these areas than would be explained by mere additive effects among the process steps.

A medical care system 124 analyzes the client 116, in step 608. The assessment module 108 and/or treatment module 104 may conduct one or more tests or gather information about the client. For example, the bioimpedance module can perform bio-impedance analysis together with the nutrition and lifestyle module 228 performing one or more nutritional and lifestyle consultations for a client. The modules 204-232 can be configured to provide health information that may be used to develop a customized/personalized treatment plan. Such testing may be accomplished using one or more of the tests, panels, etc. described herein and stored in the health parameters field 512 or the test results field 520.

Based on the test results and other information, the assessment module 108 and/or treatment module 104 may generate a care program, in step 612. Thus, the assessment module 108 can generate a customized weight loss program to utilize information from the prior step to determine the amounts, timing, quantity, presence and the like of treatment tools and modules that may be incorporated into a plan for the client. The treatment module 104 can generate other plans for the client for other (exclusively or non-exclusively) purposes such as one or more of, but not limited to, pain management, detoxification, general wellness improvements and the like and combinations thereof. The treatment plans and objectives of the client may be stored in the treatment plans field 524 and goals field 512, respectively.

One or more therapies may then be applied to the client. In embodiments, one or more modules 304-312 may be used to treat the client, in step 616. For example, the client may be treated with laser and/or body vibration therapy configured to provide beneficial therapy for clients in accordance with the customized weight-loss program or other plan. The treatment may be accomplished by the laser treatment module 304, the vibration module 308, and/or the supplement module 312.

A doctor or other organization may implement a diet and supplement program configured to augment and enhance the benefits and results of the other steps described herein by altering the regular flow of materials consumed by the client to a selection of materials that are more adapted to the plan goals. The supplement module 312 may accomplish the diet program objectives.

The client's gym or personal trainer may implement an exercise program configured to augment and enhance the benefits and results of the other steps described herein by altering the regular physical activities of the client to a selection of activities that are more adapted to the plan goals. Such may be accomplished using one or more of the modules described herein.

A follow-up module 112 can assess progress of the client, in step 620. The modules 404-424 can be configured to augment and enhance the benefits and results of the other steps described herein by altering the plan compliance of the client to a level of compliance that is more adapted to the plan goals. Results from the program may be recorded by the follow-up module 112 into the test results 516 and/or comparative test results fields 516, 520.

Thus, the follow-up module 112 can record feedback, in step 624. The follow-up module 112 may be configured to augment and enhance the benefits and results of the other steps described herein by altering the plan itself to a plan more adapted to realities of the client. Such may be accomplished using one or more of the modules 404-424 described herein.

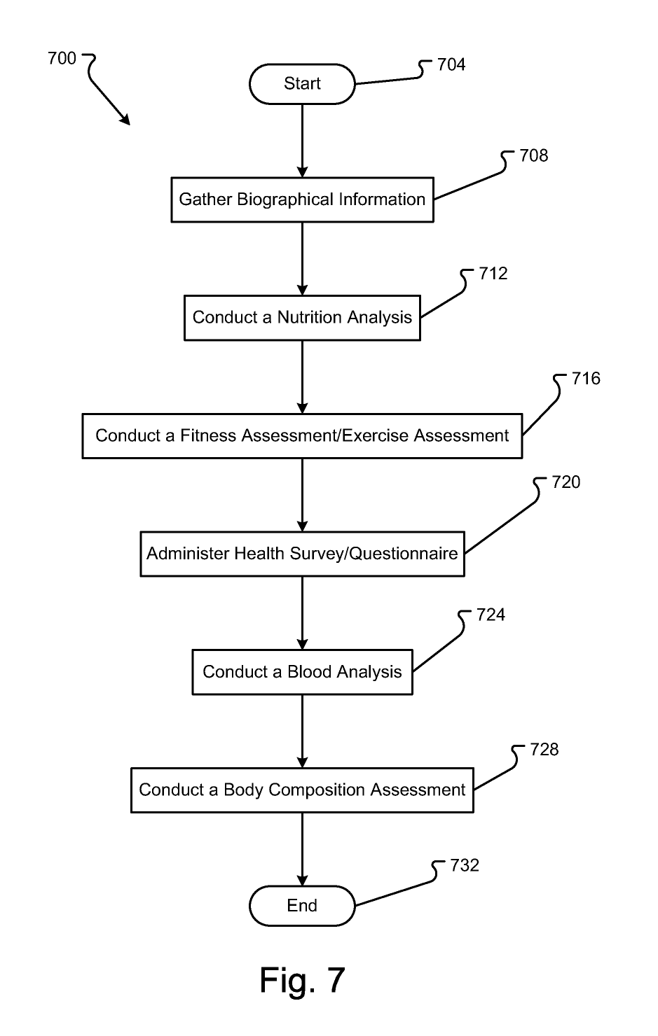

An embodiment of a method for promoting wellness is shown in FIG. 7. Generally, the method 700 starts with a start operation 704 and ends with an end operation 732. The method 700 can include more or fewer steps or can arrange the order of the steps differently than those shown in FIG. 7. The method 700 can be executed as a set of computer-executable instructions executed by a computer system and encoded or stored on a computer readable medium. Hereinafter, the method 700 shall be explained with reference to the systems, components, modules, software, data structures, user interfaces, etc. described in conjunction with FIGS. 1-6.

The assessment module 108 gathers biographical information about the client, in step 708. The biographical information collected can include information about a client's address, phone number, email address, etc. Further, the biographical information can also include the client's height, weight, age, sex, and other information about the client. The assessment module 108 can gather this information through input made from consultations with the client or with a third party. In embodiments, the assessment module 108 may then store the biographical information into field 536.

The assessment module 108 can also conduct a nutrition analysis, in step 712. Here, the assessment module 108 can accept input from a user input or other source that describes the diet or eating habits of the client. The entries may be made into a client computer 116b and sent to the assessment module 108 over the network 120. In embodiments, the assessment module 108 can accept input from a calorie counter used by a client that tracks, in near real time, what the client eats by entries into a mobile device 116b.

The assessment module 108 conducts a fitness assessment, in step 716. The assessment module 108 may be connected to an input device that records information about a fitness test. For example, a client may undergo an exercise while being measured for oxygen saturation or to determine when anaerobic activity begins. The input device can interpret the information and provide the assessment module 108 with data about the client's fitness. Also, the assessment module 108 may accept input from a user input or other source that describes the fitness or exercise habits of the client.

The assessment module 108 administers a health survey, in step 720. A health survey may be a questionnaire or consultation that determines the client's medical history and current health status. The information from the health survey may be entered as input into the assessment module 108. Further, information from a client's medical doctor or health care provider may also be input into the assessment module 108.

The assessment module 108 conducts a blood analysis, in step 724. A blood analysis may be any chemical or other test done to a sample of the client's blood. Some blood tests that may be administered have been described hereinbefore. The results of the blood test may be entered as input into the assessment module 108 either manually or automatically.

The assessment module 108 conducts a body composition assessment, in step 728. A body composition assessment can include any determination of bioimpedance, biomass, or other types of assessments. Some of these types of tests have been described hereinbefore. Further, a caliper test or other test of distribution of fat on a client may also be taken, and the data entered into the assessment module 108.

Generally, the assessment module 108 attempts to uncover any known or unknown malady from which the client is suffering. These maladies can include being overweight, poor balance, poor fitness, Parkinson's disease, diabetes, vertigo, osteoporosis, arthritis, depression, anxiety, anorexia, bulimia, high blood pressure, peripheral vascular disease, epilepsy, fibromyalgia, Multiple Sclerosis (MS), neuropathy, migraines, etc. Anyone of these maladies may be responsive to the combined laser treatment and vibration therapy.

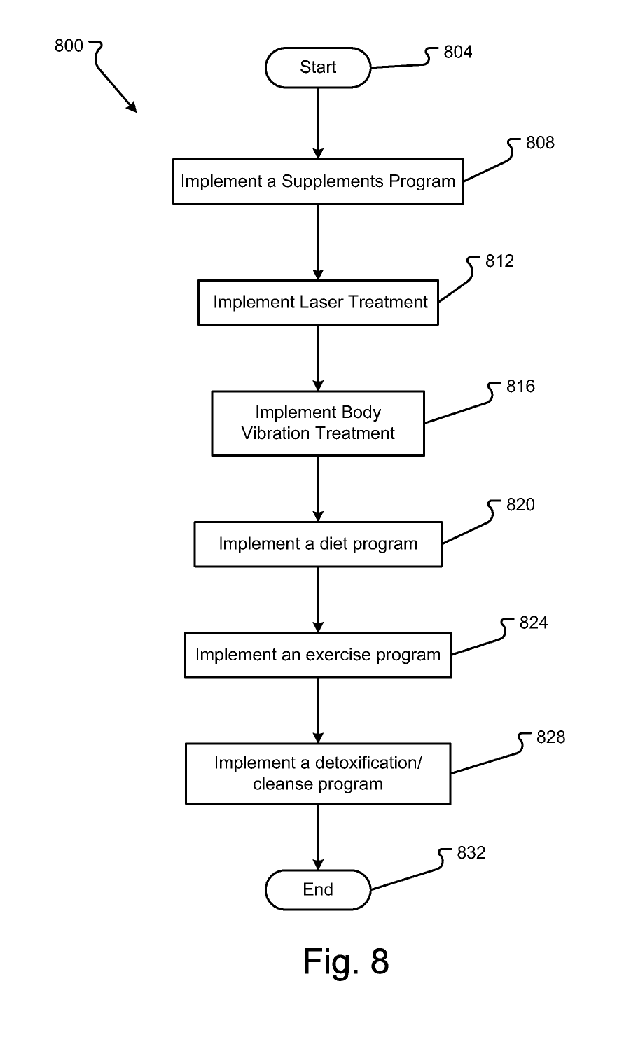

An embodiment of a method for promoting wellness is shown in FIG. 8. Generally, the method 800 starts with a start operation 804 and ends with an end operation 832. The method 800 can include more or fewer steps or can arrange the order of the steps differently than those shown in FIG. 8. The method 800 can be executed as a set of computer-executable instructions executed by a computer system and encoded or stored on a computer readable medium. Hereinafter, the method 800 shall be explained with reference to the systems, components, modules, software, data structures, user interfaces, etc. described in conjunction with FIGS. 1-5. Advantageously, such a process permits for very high levels of success for clients desiring weight loss and/or pain management, along with other enhanced health characteristics. The inventors have seen much higher levels of success in these areas than would be explained by mere additive effects among the process steps.

The treatment module 104 can implement a supplement program, in step 808. A supplement program can include any additional or enhanced drug, vitamin, mineral, or other substance taken to better the client's health. The treatment module 104 can determine the best additions to a client's diet based on the results provided by the assessment module 108. The treatment module 104 can indicate the appropriate substances to intake, when to take the supplements, and how much to take. Further, the treatment module 104 can also monitor the client for adverse reactions to the substances and to determine the effectiveness of the supplement program.

The treatment module 104 can implement a laser treatment program, in step 812. The laser treatment program can be any targeted laser treatment, as previously described. The treatment module 104 may determine the appropriate settings and application for the laser treatment device. Further, the treatment module 104 can also monitor the client for adverse reactions to the laser treatment and to determine the effectiveness of the laser treatment.

The treatment module 104 can implement a body vibration treatment, in step 816. The vibration therapy program can be any full body vibration, as previously described. The treatment module 104 may determine the appropriate settings and application for the vibration therapy device. Further, the treatment module 104 can also monitor the client for adverse reactions to the vibration therapy and to determine the effectiveness of the vibration therapy.

The treatment module 104 can implement a diet program, in step 820. A diet program can include any development or direction of what a client should eat or not eat to better the client's health. The treatment module 104 can determine the best diet or food intake based on the results provided by the assessment module 108. The treatment module 104 can indicate the appropriate foods to eat, how often and when to eat, and how much to eat. Further, the treatment module 104 can also monitor the client for food allergies and to determine the effectiveness of the diet program.

The treatment module 104 may implement an exercise regimen, in step 824. An exercise program can include any development or direction of how a client should exercise to better the client's health. The treatment module 104 can determine the best exercises or exercise program based on the results provided by the assessment module 108. The treatment module 104 can indicate the appropriate exercises, how often and when to exercise, and how often and at what intensity to exercise. Further, the treatment module 104 can also monitor the client for to determine the effectiveness of the exercise program and to adjust the exercise routine as the client becomes fit.

The treatment module 104 can implement a detoxification/cleanse program, in step 828. A detoxification/cleanse program can include any ingested or induced cleansing of a client's digestive, endocrine, or other system. The detoxification/cleanse program can include colonics, fluid washes, etc. The treatment module 104 can determine the detoxification/cleanse program based on the results provided by the assessment module 108. The treatment module 104 can indicate the appropriate types of detoxification/cleanse procedures to undergo, how often and when to undergo the detoxification/cleanse procedures, and when to stop the detoxification/cleanse procedures. Further, the treatment module 104 can also monitor the client for adverse effects to the detoxification/cleanse procedures and to determine the effectiveness of the detoxification/cleanse program.

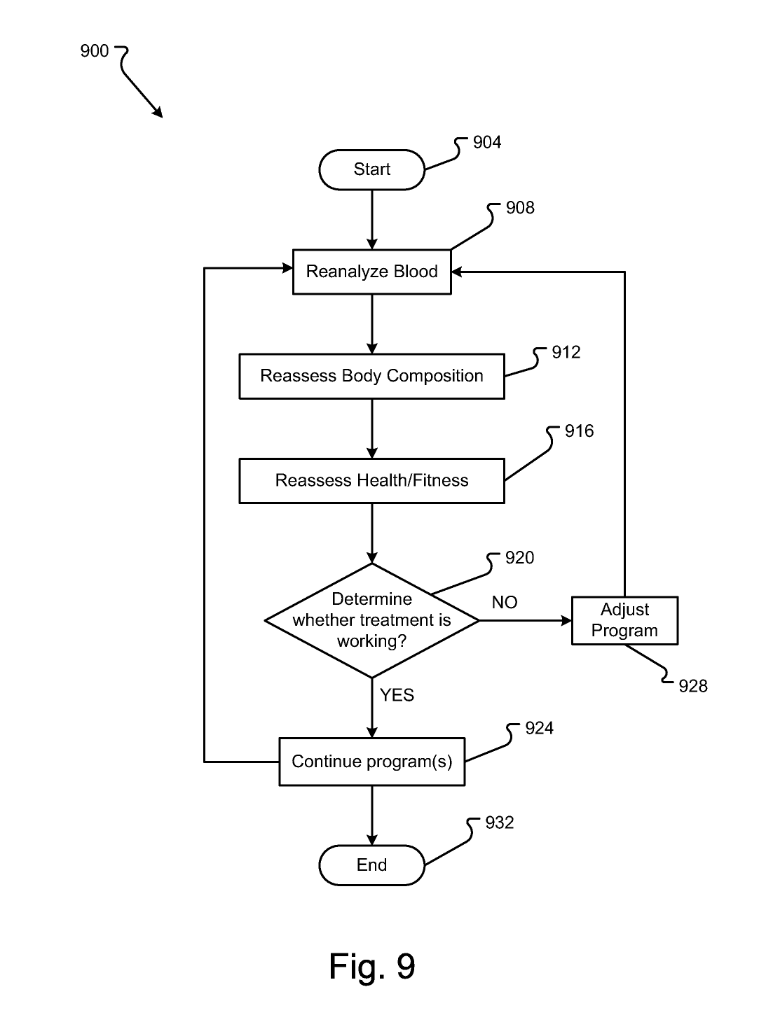

An embodiment of a method for promoting wellness is shown in FIG. 9. Generally, the method 900 starts with a start operation 904 and ends with an end operation 932. The method 900 can include more or fewer steps or can arrange the order of the steps differently than those shown in FIG. 9. The method 900 can be executed as a set of computer-executable instructions executed by a computer system and encoded or stored on a computer readable medium. Hereinafter, the method 900 shall be explained with reference to the systems, components, modules, software, data structures, user interfaces, etc. described in conjunction with FIGS. 1-5. Advantageously, such a process permits for very high levels of success for clients desiring weight loss and/or pain management, along with other enhanced health characteristics. The inventors have seen much higher levels of success in these areas than would be explained by mere additive effects among the process steps.

The follow-up module 112 can reanalyze the client's blood, in step 908. As with the blood analysis described in conjunction with FIG. 7 or the blood tests described hereinbefore, the client's blood can be analyzed for the presence or concentration or certain chemicals. The reanalysis helps determine the changes to the client and provide feedback to the client. Thus, the blood reanalysis is a repetitive administration of any blood test that can indicate the progress or changes to a client's health.

The follow-up module 112 can reassess the client's body composition, in step 912. As with the body composition assessment described in conjunction with FIG. 7 or the tests described hereinbefore, the client's body composition can be analyzed for the changes in fat distribution or other bodily transformations. The reanalysis helps determine the changes to the client and provide feedback to the client. Thus, the body composition reassessment is a repetitive administration of any test that can indicate the progress or changes to a client's health.

The follow-up module 112 can reassess the client's health and/or fitness, in step 916. As with the health surveys and/or fitness tests described in conjunction with FIG. 7 or the tests described hereinbefore, the client's health and fitness can be analyzed for the changes in aerobic conditioning, flexibility, strength, or other fitness or health indication. The reanalysis helps determine the changes to the client and provide feedback to the client. Thus, the health and fitness reassessment is a repetitive administration of any test or questionnaire that can indicate the progress or changes to a client's health.

The follow-up module 112 can determine whether the care program or treatment is working, in step 920. Here, the follow-up module 112 can compare the client's response to the combined laser treatment and vibration therapy to other clients having similar heath parameters and goals. In other embodiments, the follow-up module 112 can determine the progress of the client based on previous measurements. Still further, the follow-up module 112 can determine the satisfaction of the client with the care program. For example, when a client is following the protocol and their hormones are balanced, the client should realize a weight loss or inch loss of substantially near 6 to 9 inches, with the first series of substantially 6 to 9 treatments. Also, the follow-up module 112 can comparing a client's progress to at least one statistical parameter to determine if results from the combined laser treatment and vibration therapy are as expected. If the client is not progressing, the method 900 flows “NO” to step 928, where the follow-up module 112 can adjusting the care program. If the client is progressing, the method 900 flows “YES” to step 924, where the follow-up module 112 can continue the care program at least until the client meets his or her goal(s).

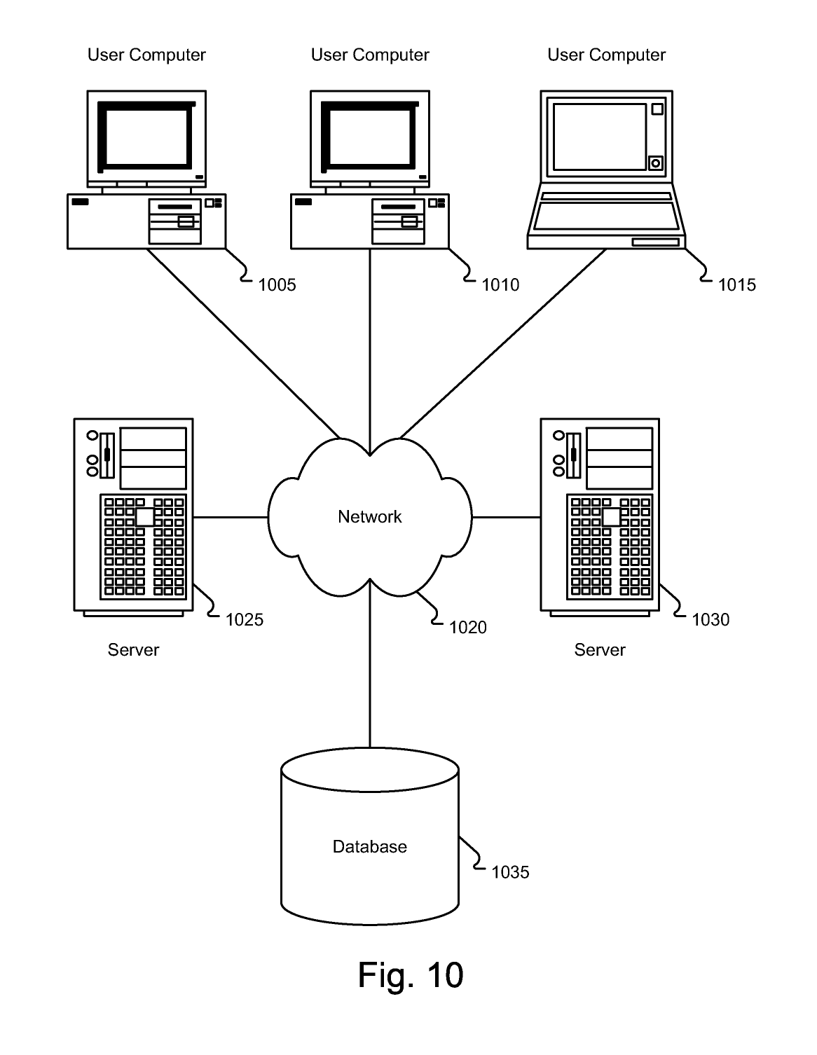

A block diagram of a computing environment 1000 that may function as system or environment for the embodiments described herein is shown in FIG. 10. The system 1000 includes one or more user computers 1005, 1010, and 1015. The user computers 1005, 1010, and 1015 may be general purpose personal computers (including, merely by way of example, personal computers and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 1005, 1010, and 1015 may also have any of a variety of applications, including for example, database client and/or server applications, and web browser applications. Alternatively, the user computers 1005, 1010, and 1015 may be any other electronic device, such as a thin-client computer, Internet-enabled mobile telephone, and/or personal digital assistant, capable of communicating via a network (e.g., the network 1020 described below) and/or displaying and navigating web pages or other types of electronic documents. Although the exemplary system 1000 is shown with three user computers, any number of user computers may be supported.

System 1000 further includes a network 1020. The network 1020 can be any type of network familiar to those skilled in the art that can support data communications using any of a variety of commercially-available protocols, including, without limitation, TCP/IP, SNA, IPX, AppleTalk, and the like. Merely by way of example, the network 1020 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth™ protocol known in the art, and/or any other wireless protocol); and/or any combination of these and/or other networks.

The system 1000 may also include one or more server computers 1025, 1030. One server may be a web server 1025, which may be used to process requests for web pages or other electronic documents from user computers 1005, 1010, and 1015. The web server can be running an operating system including any of those discussed above, as well as any commercially-available server operating systems. The web server 1025 can also run a variety of server applications, including HTTP servers, FTP servers, CGI servers, database servers, Java servers, and the like. In some instances, the web server 1025 may publish operations available operations as one or more web services.

The system 1000 may also include one or more file and or/application servers 1030, which can, in addition to an operating system, include one or more applications accessible by a client running on one or more of the user computers 1005, 1010, 1015. The server(s) 1030 may be one or more general purpose computers capable of executing programs or scripts in response to the user computers 1005, 1010 and 1015. As one example, the server may execute one or more web applications. The web application may be implemented as one or more scripts or programs written in any programming language, such as Java™, C, C#™ or C++, and/or any scripting language, such as Perl, Python, or TCL, as well as combinations of any programming/scripting languages. The application server(s) 1030 may also include database servers, including without limitation those commercially available from Oracle, Microsoft, Sybase™, IBM™ and the like, which can process requests from database clients running on a user computer 1005.

The web pages created by the web application server 1030 may be forwarded to a user computer 1005 via a web server 1025. Similarly, the web server 1025 may be able to receive web page requests, web services invocations, and/or input data from a user computer 1005 and can forward the web page requests and/or input data to the web application server 1030. In further embodiments, the server 1030 may function as a file server. Although for ease of description, FIG. 5 illustrates a separate web server 1025 and file/application server 1030, those skilled in the art will recognize that the functions described with respect to servers 1025, 1030 may be performed by a single server and/or a plurality of specialized servers, depending on implementation-specific needs and parameters. The computer systems 1005, 1010, and 1015, file server 1025 and/or application server 1030 may function as servers or other systems described herein.

The system 1000 may also include a database 1035. The database 1035 may reside in a variety of locations. By way of example, database 1035 may reside on a storage medium local to (and/or resident in) one or more of the computers 1005, 1010, 1015, 1025, 1030. Alternatively, it may be remote from any or all of the computers 1005, 1010, 1015, 1025, 1030, and in communication (e.g., via the network 1020) with one or more of these. In a particular set of embodiments, the database 1035 may reside in a storage-area network (“SAN”) familiar to those skilled in the art. Similarly, any necessary files for performing the functions attributed to the computers 1005, 1010, 1015, 1025, 1030 may be stored locally on the respective computer and/or remotely, as appropriate. In one set of embodiments, the database 1035 may be a relational database, such as Oracle 10i™, that is adapted to store, update, and retrieve data in response to SQL-formatted commands. Database 1035 may be the same or similar to the database used herein.

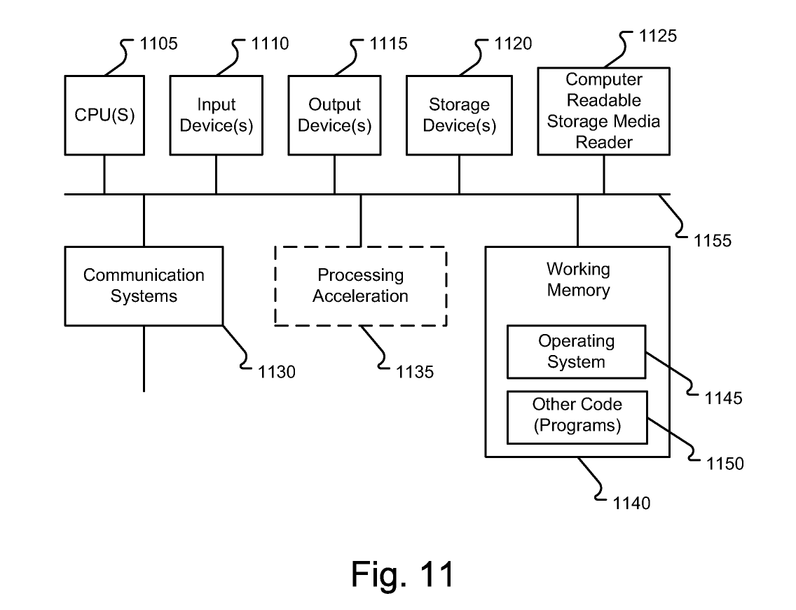

One embodiment of a computer system 1100 upon which servers or other systems described herein may be deployed or executed is shown in FIG. 11. The computer system 1100 is shown comprising hardware elements that may be electrically coupled via a bus 1155. The hardware elements may include one or more central processing units (CPUs) 1105; one or more input devices 1110 (e.g., a mouse, a keyboard, etc.); and one or more output devices 1115 (e.g., a display device, a printer, etc.). The computer system 1100 may also include one or more storage device 1120. By way of example, storage device(s) 1120 may be disk drives, optical storage devices, solid-state storage device such as a random access memory (“RAM”) and/or a read-only memory (“ROM”), which can be programmable, flash-updateable and/or the like.

The computer system 1100 may additionally include a computer-readable storage media reader 1125; a communications system 1130 (e.g., a modem, a network card (wireless or wired), an infra-red communication device, etc.); and working memory 1140, which may include RAM and ROM devices as described above. In some embodiments, the computer system 1100 may also include a processing acceleration unit 1135, which can include a DSP, a special-purpose processor and/or the like.

The computer-readable storage media reader 1125 can further be connected to a computer-readable storage medium, together (and, optionally, in combination with storage device(s) 1120) comprehensively representing remote, local, fixed, and/or removable storage devices plus storage media for temporarily and/or more permanently containing computer-readable information. The communications system 1130 may permit data to be exchanged with the network 1120 and/or any other computer described above with respect to the system 1100. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 1100 may also comprise software elements, shown as being currently located within a working memory 1140, including an operating system 1145 and/or other code 1150, such as program code implementing the servers or devices described herein. It should be appreciated that alternate embodiments of a computer system 1100 may have numerous variations from that described above. For example, customized hardware might also be used and/or particular elements might be implemented in hardware, software (including portable software, such as applets), or both. Further, connection to other computing devices such as network input/output devices may be employed.

The following are exemplary sample/fictitious descriptions of implementations of a non-limiting embodiment of the system/method described herein:

1) Client #1 suffers from Parkinson's. He is a 72 year old male and is so shaky he cannot even hold a pencil. After the initial intake, which consisted of full medical history including drugs prescribed and diet he was put on a regimen of Power Plate one time per week for thirty minutes for two weeks and some of the ‘toxic’ things he was eating were eliminated. After two weeks Power Plate was increased to two times per week for two weeks, diet was monitored again and some foods were changed. After the first month, he was put on Power plate three times per week and is now at 60 minutes of exercise and stretching therapy. We also utilized laser therapy for sore joints as needed. He can now drive a car, he plays tennis three times a week and sails his boat. For this client, the whole body vibration works opposite as it does for someone without Parkinson's. The 3-dimensional vibration calms the nerves down. In addition, the following benefits are recognized:

Risk of fall. Most clients with Parkinson's present with shuffling gait, and even small obstacles tend to trip them. Gait freezing, characterized by an inability to move the feet, also increase the chance of falling

Fatigue level

Dizziness and fainting due to orthostatic hypotension

Impaired fine and gross motor coordination

Slowed voluntary and involuntary motor responses (reaction time)

Dementia (20-40% of clients), hallucinations and paranoia

Medication effects

Excessive daytime somnolence due to poor sleeping patterns

Impaired proprioception

Pain sensations due to muscle rigidity and compensation patterns

The Power Plate will most likely not have any effect on the disease, but can improve fitness and wellbeing so symptoms are reduced. The treatment includes:

Stability and coordination training on the Power Plate have been shown to improve both intra-muscular and inter-muscular coordination. These two components play an essential role in gait control.

The Power Plate produces 25 to 50 vibrations per second, causing the muscles to contract reflexively. This high demand of muscle activity will cause more motor units to fire at the right time, at the right speed and with a better synchronization (therefore improving both fine and gross motor coordination as well as reaction time).

Many clients using the Power Plate report improved sleeping patterns, which may be due to a decreased cortisol level. Power Plate may have positive influence on PD clients' sleep cycles and reduce daytime somnolence.

Slowed voluntary and involuntary motor responses (reaction time)

The tri-dimensional displacement of the Power Plate platform is optimal to improve proprioception and motor control in all planes of motion.

Pain sensations can be decreased due to the high level of stimulation of the mechano-receptors and desensitization of the pain receptors.

Power Plate training enhances the response of fast twitch muscle fibers, leading to a higher speed of movement, limiting the chance of falling.

Power Plate can help diminish muscle stiffness and increase flexibility through stretching modalities performed with vibration.

2) Client #2 is a middle-aged woman. She suffers from migraines (8-12 per month) and fibromyalgia. She is depressed due to the weight she's gained and has lost her desire to work out. She is put on a 9-laser treatment package, which includes 9 30 minute Power Plate sessions. She is measured before and after each laser treatment, and at the 3rd treatment no progress has been made. A blood panel is ordered and its discovered that she is peri-menopausal. HRT is prescribed, and after one month the laser treatments can begin. In the meantime, after an in depth discussion on her diet, its discovered that she is eating foods that actually trigger her fibromyalgia. She stays on the Power Plate, changes her diet and starts a 10-day detox and certain foods are gradually added back into her diet, minus the triggers. Her laser treatments start and after 3 treatments she has lost 3.5″. Due to her exercise on Power Plate, her bone density has increased and her migraines have decreased to 2 per month. PowerPlate® is recommended because it creates 25-50 vibrations per second, causing the body's nervous system to respond each and every time. The vibration stimulates one of the body's natural reflexes. This reflex works at an unconscious level, like a knee-jerk reflex, meaning that you are not even aware that it is happening. The vibration causes more of the muscles to contract, at a rate of 25-50 contractions per second.

With that many muscles contracting that fast, your nervous and vascular systems are working extremely fast, so your body has no choice but to respond to the physiological changes.

Here are some changes that take place in your body:

Increased strength and muscle tone

Improved circulation

Increased bone density,

Enhanced balance and coordination,

Weight loss and Cellulite reduction

Decreased pain

Improved well being

Stress reduction by means of improved hormone levels

Recovery and regeneration of damaged tissue

Increase of growth hormones

Due to the involuntary contractions that occur in response to the vibration, clients with limited mobility and debilitating conditions (such as arthritis, Fibromyaglia, Parkinson's and Multiple sclerosis) can perform pain free movements, and can reap the same benefits that a pro athlete receives.

Laser therapy is recommended because the laser increases blood flow, and reduces inflammation so we can focus on the area necessary and increase blood flow and reduce inflammation to manage the pain from migraines and fibromyalgia.

1. 3) Client #3 is a 35 year old woman who is 35 pounds overweight. She has tried everything to no avail, and is depressed. We put her on a restricted diet, and have her do 12 laser treatments with 12 Power Plate sessions, starting at 30 minutes and working up to an hour. We supplement her with Xymogen Niacin, Green Tea, Max Ala and Glycemic Cleanse to jump start her metabolism, and support her adrenal system as she de-tox's. After 3 laser treatments she has lost 4″ and 3 pounds. After 6 treatments she has lost 6″ and 3 more pounds. At the end of her 12 treatments, she has lost a total of 32 pounds and 14″ overall. The Power Plate® workout can contribute to a loss of fatty tissue in your body. The Power Plate® device has such influence on some of the essential processes involved, it can, in fact, aid weight loss. As with any other activity, however, you will also have to pay attention to your calorie intake. Because the division between fatty tissue and muscles are positively influenced, training on the Power Plate® device will speed up the basic metabolism, leading to higher energy consumption. In short, if the energy intake is constant and its consumption rises, logically a negative energy balance will be the result. In other words, you will decrease the amount of fatty tissue. However, this decrease does not correspond directly to your weight, as muscle tissue is heavier than fatty tissue.

Many of the processes in our body, among others burning calories, are regulated by hormones. These hormones are effectors, in other words, they can start a process in the body, speed it up or slow it down as necessary. If you train on Power Plate® equipment, your body will be stimulated to produce all kinds of hormones involved in the recuperation processes, which have a significant influence on reducing fatty tissues, such as the Human Growth Hormone. All of these factors can bring about a considerable reduction of fatty tissue, if combined with a program of the proper intensity.

Because the laser opens a pore in the fat cell to allow it to detox, accelerated weight and inch loss is recognized because the Power Plate work out stimulates the lymphatic system and increases elimination of the fats and other toxins released into the system.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. Various databases used herein may include: customer health information, treatment protocols, equipment specifications, test results, comparative test result data, treatment grids based on test results, and/or like data useful in the operation of the embodiments. As those skilled in the art will appreciate, any computers discussed herein may include an operating system (e.g., Windows Vista, NT, 95/98/2000, 0S2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The embodiments may be described herein in terms of functional block components, screen shots, user interaction, optional selections, various processing steps, and the like. Each of such described herein may be one or more modules in exemplary embodiments. It should be appreciated that such functional blocks may be realized by any number of hardware and/or software components configured to perform the specified functions. For example, the embodiments may employ various integrated circuit components, e.g., memory elements, processing elements, logic elements, look-up tables, and the like, which may carry out a variety of functions under the control of one or more microprocessors or other control devices. Similarly, the software elements of the embodiments may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the embodiments may employ any number of conventional techniques for data transmission, signaling, data processing, network control, and the like. Still further, the embodiments may detect or prevent security issues with a client-side scripting language, such as JavaScript, VBScript or the like.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a Personal Computer (PC), laptop, netbook, smart phone, Personal Digital Assistant (PDA), tablet, etc., or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In some embodiments, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

What is claimed is:

1. A method for promoting wellness comprising:
a computer system, having one or more modules, analyzing a client;
based on the analysis of the client, a computer system generating a care program, wherein generating the care program includes determining suitability of the client for combined laser treatment and vibration therapy;
providing vibration therapy with laser treatment;
the computer system generating a follow-up program, including reassessing the client's suitability for combined laser treatment and vibration therapy;
the computer system implementing a feedback program; and
the computer system adjusting the care program based on the reassessment of the client.

2. The method for promoting wellness of claim 1, wherein analyzing the client comprises one or more of:
gathering biographical information about the client;
conducting a nutrition analysis;
conducting a fitness assessment;
administering a health survey;
conducting a blood analysis; and/or conducting a body composition assessment.

3. The method for promoting wellness of claim 2, wherein, based on the client analysis, the client is deemed suitable for combined laser treatment and vibration therapy, and wherein the client is suitable for combined laser treatment and vibration therapy if the client has one or more of the following conditions:
Overweight;
Poor balance;
Poor fitness;
Parkinson's disease;
Diabetes;
Vertigo;
Osteoporosis;
Arthritis;
Depression;
Anxiety;
Anorexia;
Bulimia;
High blood pressure;
Fibromyalgia;
Multiple Sclerosis;
Neuropathy;
Migraines;
Peripheral vascular disease; and/or
Epilepsy.

4. The method for promoting wellness of claim 1, wherein generating the care program further includes one or more of
implementing a diet program;
implementing an exercise regimen;
implementing a supplement program; and/or
implementing a detoxification/cleanse program;

5. The method for promoting wellness of claim 1, wherein generating the follow-up program includes one or more of:
reanalyzing the client's blood
reassessing the client's body composition; and/or
reassessing the client's health and/or fitness.

6. The method for promoting wellness of claim 5, wherein generating the follow-up program includes determining whether the combined laser treatment and vibration therapy is meeting the client's goals.

7. The method for promoting wellness of claim 6, wherein determining whether the combined laser treatment and vibration therapy is meeting the client's goals includes one or more of:
comparing the client's response to the combined laser treatment and vibration therapy to other clients having similar heath parameters and goals;
determining the progress of the client based on previous measurements; and/or
determining the satisfaction of the client with the care program

8. The method for promoting wellness of claim 7, further comprising comparing a client's progress to at least one statistical parameter to determine if results from the combined laser treatment and vibration therapy are as expected.

9. The method for promoting wellness of claim 8, further comprising: if the client is not progressing, adjusting the care program.

10. The method for promoting wellness of claim 8, further comprising: if the client is progressing, continuing the care program at least until the client meets his or her goal(s).

11. A computing system, comprising:
a memory;
a processor in communication with the memory, the processor operable to execute one or more modules including:
an assessment/treatment management module operable to analyze a client;
based on the analysis of the client, a treatment module operable to generate a care program, wherein generating the care program includes determining suitability of the client for combined laser treatment and vibration therapy;
the treatment module operable to assist in providing vibration therapy with laser treatment;
a follow-up module operable to generate a follow-up program, including reassessing the client's suitability for combined laser treatment and vibration therapy; and
the follow-up module operable to adjust the care program based on the reassessment of the client.

12. The method for promoting wellness of claim 11, wherein the assessment treatment management module is further operable to:
gather biographical information about the client;
conduct a nutrition analysis;
conduct a fitness assessment;
administer a health survey;
conduct a blood analysis; and/or
conduct a body composition assessment.

13. The method for promoting wellness of claim 12, wherein, based on the client analysis, the client is deemed suitable for combined laser treatment and vibration therapy, and wherein the client is suitable for combined laser treatment and vibration therapy if the client has one or more of the following conditions:
Overweight;
Poor balance;
Poor fitness;
Parkinson's disease;
Diabetes;
Vertigo;
Osteoporosis;
Arthritis;
Depression
Anxiety;
Anorexia;
Bulimia;
Fibromyalgia;
Multiple Sclerosis;
Neuropathy;
Migraines;
High blood pressure;
Peripheral vascular disease; and/or
Epilepsy.

14. The method for promoting wellness of claim 1, wherein the treatment module is further operable to:
implement a diet program;
implement an exercise regimen;
implement a supplement program; and/or
implement a detoxification/cleanse program;

15. The method for promoting wellness of claim 1, wherein the follow-up module is further operable to:
reanalyze the client's blood
reassess the client's body composition;
reassess the client's health and/or fitness;
determine whether the combined laser treatment and vibration therapy is meeting the client's goals, wherein determining whether the combined laser treatment and vibration therapy is meeting the client's goals includes one or more of:
compare the client's response to the combined laser treatment and vibration therapy to other clients having similar heath parameters and goals;
determine the progress of the client based on previous measurements; and/or determine the satisfaction of the client with the care program;
comparing a client's progress to at least one statistical parameter to determine if results from the combined laser treatment and vibration therapy are as expected;
wherein, if the client is not progressing, adjust the care program; and
wherein, if the client is progressing, continue the care program at least until the client meets his or her goal(s).

16. A tangible computer readable medium having stored thereon computer-executable instructions that when executed by a computing system cause the computing system to perform a method for promoting wellness, the computer-executable instructions comprising:
instructions to analyze a client;
based on the analysis of the client, instructions to generate a care program, wherein generating the care program includes determining suitability of the client for combined laser treatment and vibration therapy;
instructions to assist in providing vibration therapy with laser treatment;
instructions to generate a follow-up program, including reassessing the client's suitability for combined laser treatment and vibration therapy; and
instructions to adjust the care program based on the reassessment of the client.

17. The method for promoting wellness of claim 11, wherein the computer-executable instructions further include instructions to:
gather biographical information about the client;
conduct a nutrition analysis;
conduct a fitness assessment;
administer a health survey;
conduct a blood analysis; and/or
conduct a body composition assessment.

18. The method for promoting wellness of claim 12, wherein, based on the client analysis, the client is deemed suitable for combined laser treatment and vibration therapy, and wherein the client is suitable for combined laser treatment and vibration therapy if the client has one or more of the following conditions:
Overweight;
Poor balance;
Poor fitness;
Parkinson's disease;
Diabetes;
Vertigo;
Osteoporosis;
Arthritis;
Depression
Anxiety;
Anorexia;
Bulimia;
Fibromyalgia;
Multiple Sclerosis;
Neuropathy;
Migraines;
High blood pressure;
Peripheral vascular disease; and/or
Epilepsy.

19. The method for promoting wellness of claim 1, wherein the computer-executable instructions further include instructions to:
implement a diet program;
implement an exercise regimen;
implement a supplement program; and/or
implement a detoxification/cleanse program;

20. The method for promoting wellness of claim 1, wherein the computer-executable instructions further include instructions to:
reanalyze the client's blood
reassess the client's body composition;
reassess the client's health and/or fitness;
determine whether the combined laser treatment and vibration therapy is meeting the client's goals, wherein determining whether the combined laser treatment and vibration therapy is meeting the client's goals includes one or more of:
compare the client's response to the combined laser treatment and vibration therapy to other clients having similar heath parameters and goals;
determine the progress of the client based on previous measurements; and/or
determine the satisfaction of the client with the care program;
comparing a client's progress to at least one statistical parameter to determine if results from the combined laser treatment and vibration therapy are as expected;
wherein, if the client is not progressing, adjust the care program; and
wherein, if the client is progressing, continue the care program at least until the client meets his or her goal(s).
